(19) United States
(12) Patent Application Publication
(10) Pub. No.: US 2022/0253486 A1
(43) Pub. Date: Aug. 11, 2022

(54) MACHINE LEARNING APPLICATIONS TO IMPROVE ONLINE JOB LISTINGS

(71) Applicant: Jobiak LLC, Westford, MA (US)

(72) Inventors: Venkata Rao KANNAM, Andhra Pradesh (IN); Jainendra KUMAR, Telanagana (IN); Bhanu Kishore KALLEPALLI, Telanagana (IN); Venkata JANAPAREDDY, Westford, MA (US); Parshu KULKARNI, San Ramon, CA (US)

(73) Assignee: Jobiak LLC, Westford, MA (US)

(21) Appl. No.: 17/667,491

(22) Filed: Feb. 8, 2022

Related U.S. Application Data
(60) Provisional application No. 63/147,145, filed on Feb. 8, 2021.

(51) Int. Cl. G06F 16/951

(52) U.S. Cl. CPC G06F 16/951; G06N 20/00

(57) ABSTRACT

A system is designed to crawl known job listings web pages and extract the job listing URLs. A machine learning model is trained to recognize job listings and extract relevant information for the job listings. The model can separate multiple job listings on a single page. The machine learning model can further predict the likelihood of new jobs being added or existing job postings expiring. By using the prediction, the system can subsequently verify that a job expected to expire has expired and remove the same from the results. Similarly, the system can crawl websites with a high likelihood of new job postings without having to crawl the entire internet to maintain an up to date job listing repository.

### CROSS-REFERENCE TO RELATED APPLICATIONS

This application claims the benefit of U.S. Provisional Patent Application No. 63/147,145, filed Feb. 8, 2021, the contents of which are incorporated herein by reference in its entirety.

### COPYRIGHT NOTICE

© 2021 JOBIAK LLC. A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR § 1.71(d).

### BACKGROUND

The internet has proven useful for employers to advertise job openings, and it has enabled users to search for job opening of interest to them. Employers may post job listings on their company websites, and/or post them on various “job board” websites. Some sites work to collect job listings from employer websites and aggregate them on a single website or platform. These sites or “electronic job boards” may contain millions of job listings, so various filtering and search tools are provided for users. FIG. 1 is an example job search results web page.

One challenge is to keep such job listings current—they are changing constantly. New openings are listed by employers, while some listings expire or are otherwise withdrawn or canceled. The need remains for practical solutions to keep job listing sites or databases current, accurate and complete.

### SUMMARY

The following is a summary of the invention in order to provide a basic understanding of some aspects of the invention. This summary is not intended to identify key/critical elements of the invention or to delineate the scope of the invention. Its sole purpose is to present some concepts of the invention in a simplified form as a prelude to the more detailed description that is presented later.

In one aspect, the present disclosure teaches methods and systems to keep job listing data up to date in a constantly changing environment. More specifically, in one aspect, the present disclosure teaches how to find what job listings are expired, or soon to expire, without having to check every one of millions of listings. In another aspect, the present disclosure teaches how to find new job listings, without having to search the entire internet (tens of millions of websites in the U.S. alone) or even having to search websites the few hundred thousand companies known to be employers. These large-scale searching and “scraping” projects are too expensive and time consuming to be practical. In another aspect, the present disclosure teaches how to find and accurately import individual job listings that may be among multiple jobs listed on a single web page.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes executing a crawler system. The executing also includes performing, by the crawler system, crawl events may include new job data; executing a machine learning model on the new job data to predict a number of new jobs likely to be posted by an employer within a first period of time, determining that a likelihood of an employer posting a new job within the first period of time is above a threshold likelihood, and executing a second crawl event on the employer. Other embodiments of this aspect include corresponding computer systems, apparatus, and computer programs recorded on one or more computer storage devices, each configured to perform the actions of the methods.

Implementations may include one or more of the following features. The method as where the machine learning model may include features including one or more of a location, a company, a job category, a number of jobs existing for the employer on a particular day, a number of jobs expired for the employer on the particular day, a first average expiry time of a job with the employer, and a second average expiry time of a job in a job category. The method as may include presenting, in a user interface of a display, the new job data. The crawl events further may include job expiration data and may include determining, based at least in part on an expiry prediction model, a likelihood that a given job will expire by a second time. The method as may include performing, based on the expiry prediction model and at the second time, a third crawl event to determine that the given job has expired. The method as may include removing, the given job, from a database of open jobs. The machine learning model may include a regression algorithm. Implementations of the described techniques may include hardware, a method or process, or computer software on a computer-accessible medium.

Additional aspects and advantages of this invention will be apparent from the following detailed description of preferred embodiments, which proceeds with reference to the accompanying drawings.

### BRIEF DESCRIPTION OF THE DRAWINGS

The accompanying drawings are part of the disclosure and are incorporated into the present specification. The drawings illustrate examples of embodiments of the disclosure and, in conjunction with the description and claims, serve to explain, at least in part, various principles, features, or aspects of the disclosure. Certain embodiments of the disclosure are described more fully below with reference to the accompanying drawings. However, various aspects of the disclosure may be implemented in many different forms and should not be construed as being limited to the implementations set forth herein. Like numbers refer to like, but not necessarily the same or identical, elements throughout.

FIG. 1 is an example job search results web page, in accordance with some embodiments;

FIG. 2A is a high-level, simplified example process diagram to find valid links in an html webpage and input them to a classifier for jobs data analysis, in accordance with some embodiments;

FIG. 2B is a continuation from FIG. 2A that selects top links from the classifier and further processes them to find links to job listings on a-subject site, in accordance with some embodiments;

FIG. 3A is a first part of a simplified data flow diagram of an example process to efficiently and effectively scrape websites to acquire job listings and keep them current, in accordance with some embodiments;

FIG. 3B is a continuation of FIG. 3A, in accordance with some embodiments;

FIG. 3C is a continuation of FIG. 3B, in accordance with some embodiments;

FIG. D is a continuation of FIG. 3C, in accordance with some embodiments;

FIG. 3E is a continuation of FIG. 3D, in accordance with some embodiments;

FIG. 4 is a high-level, simplified flow diagram of an example process to identify individual jobs, in accordance with some embodiments;

FIG. 5 is a high-level, simplified flow diagram of an example process to identify new jobs listings to update a jobs database, in accordance with some embodiments; and

FIG. 6 is a high-level, simplified flow diagram of an example process to predict job listing expirations to update a jobs database, in accordance with some embodiments.

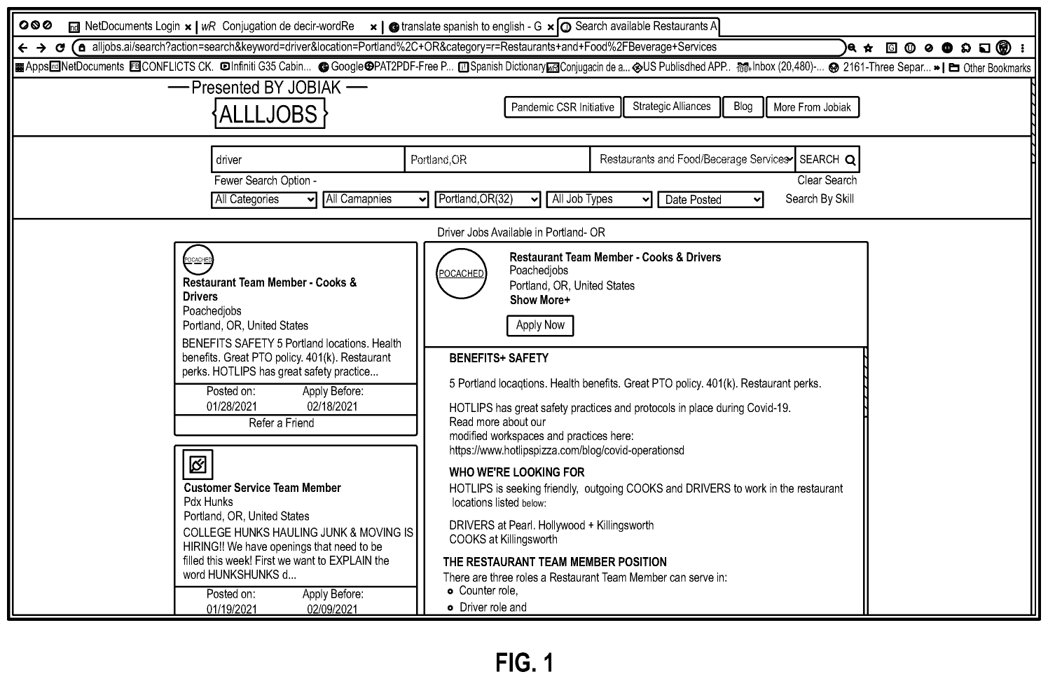

### DETAILED DESCRIPTION

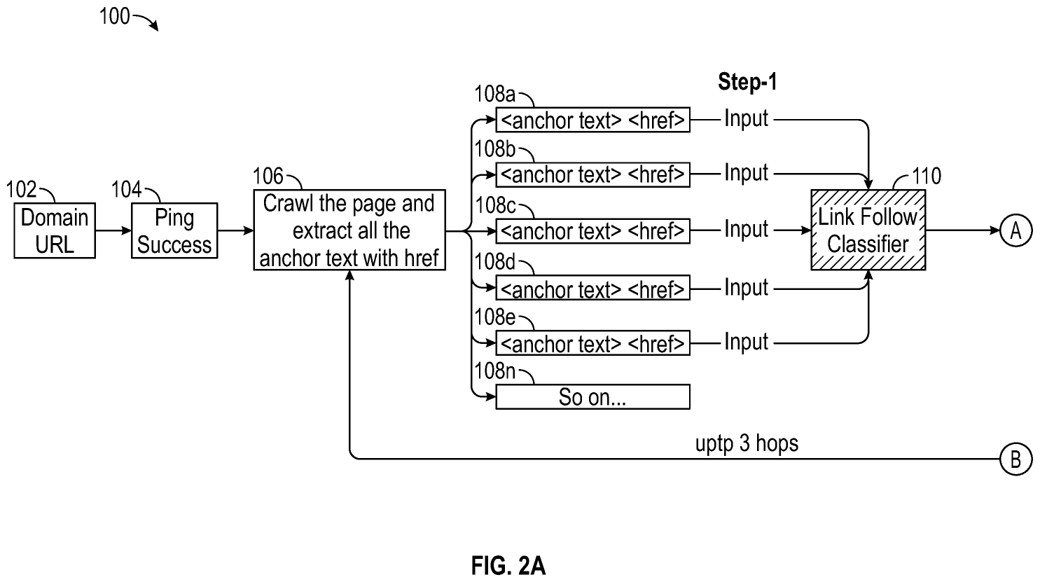

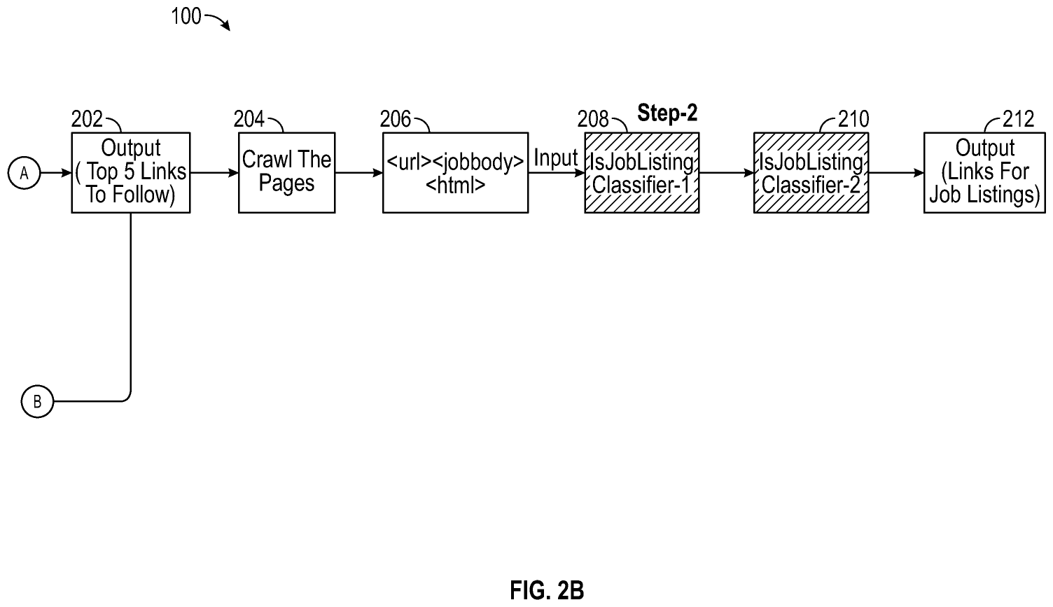

FIG. 2A is a high-level, simplified flow diagram of an example process 100. In an embodiment, publicly available sources may be inspected to acquire the names, and Domain URLs 102, for companies that may be or are known to be employers. As shown in the drawing figure, for each domain URL 102, may first be pinged to confirm validity 104. In some embodiments, features used in an ML model to identify web pages likely to have jobs listed may include:
url
html (e.g., after removing header, footer, sidebar and javascript code)
plaintext from above html

The page or pages (e.g., home page or landing page) may be crawled 106 to identify and extract all the anchor texts, such as 108a, 108b, 108c, . . . 108n, with their corresponding hypertext references (“hrefs”) from the (usually) HTML code. Each anchor may be input to a link follow classifier 110. In some examples, the purpose of the link follow classifier 110 is to narrow down the number of links to crawl. The input to the link follow classifier 110 may be the domain url 102 and its output may be the domain link follow URLs with confidence as to whether the link is likely to lead to a job listing.

FIG. 2B is a continuation from FIG. 2A and illustrates that the top links are selected from the classifier 202 and further processes them to select links in a page most likely leading to job listings. At a high level, the objective is to identify the job listing page of a domain, which may be done by the link follow classifier to narrow down the number of links to crawl. The input is a domain URL and the output is a link follow URLS with a confidence. In some cases, a second step identifies, with the IsJobListing Classifier-1 208 to identify probable job listing pages. Its input is the output link from the first step and its output is a true/false determination of whether a page is a job listings page. The IsJobListing Classifier-2 210 may identify a single job listing from the IsJobListing Classifier-1 208 output.

The top candidate pages ba-sed on confidence, along with other pages, may be crawled. Specifically, in some instances, the process loops back to crawl the page step 106 to parse each of the candidate pages to identify and extract all the anchor texts with their corresponding hrefs. The process iterates as needed down to the lowest level (page path) as necessary, or it may be limited to a desired set of levels, such as, for example, five levels in some embodiments. The selected pages may be crawled 204 to acquire key terms, generate probability scores, and determine indicators. The process 100 may input a term 206, such as [<jobbody>??] to an IsJobListing Classifier 208 which may be used to identify probable job listing pages. Of course, the labels associated with the classifiers are arbitrary and any label may be used. In some cases, the input to the IsJobListing Classifier 208 is the links output from the prior step 206, and the output from the IsJobListing Classifier 208 may be a binary decision, such as is true (job listing page) or false (not a job listing page). In some cases, a probability of the page including a job listing page is generated, which may be used by the process to set a threshold for whether the page includes job related posting information.

According to some embodiments, if the page probability indicates that the page is a job listing page, the page may be input to a second classifier, such as, “IsJobListing” Classifier-2 210 which may determine whether the page appears to list more than one job (on a single page); this may be called an omnibus job page. The output 212 from IsJobListing Classifier-2 210 then provides links for job listing pages along with indication as to which of them are likely to be omnibus pages. For each individual job listing (not on an omnibus page), the process may proceed to acquire the specific job data and add it to the jobs database.

In other words, the process 100 proceeds by narrowing down the number of links to crawl by executing the link follow classifier 110. Its input includes a domain URL, and its output is a link follow URL with confidence. The process continues by executing the IsJobClassifier 208 to identify probable job listing pages. The input for this step is the output from the Link Follow Classifier 110 and its output is whether the page includes a job listing or not. The IsJobListing Classifier-2 may then be executed to determine an omnibus page.

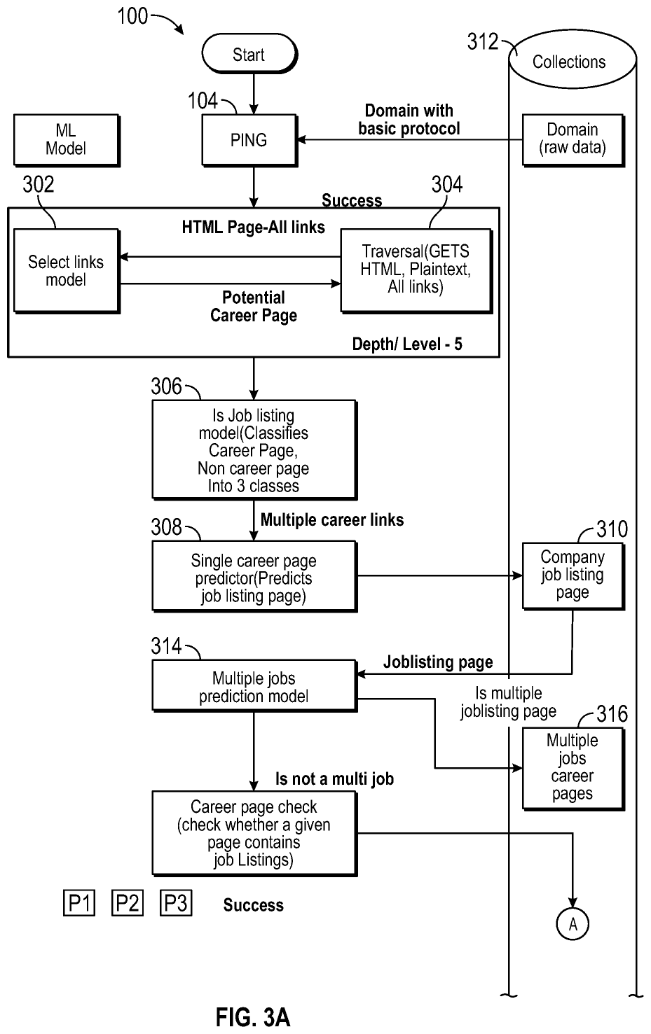

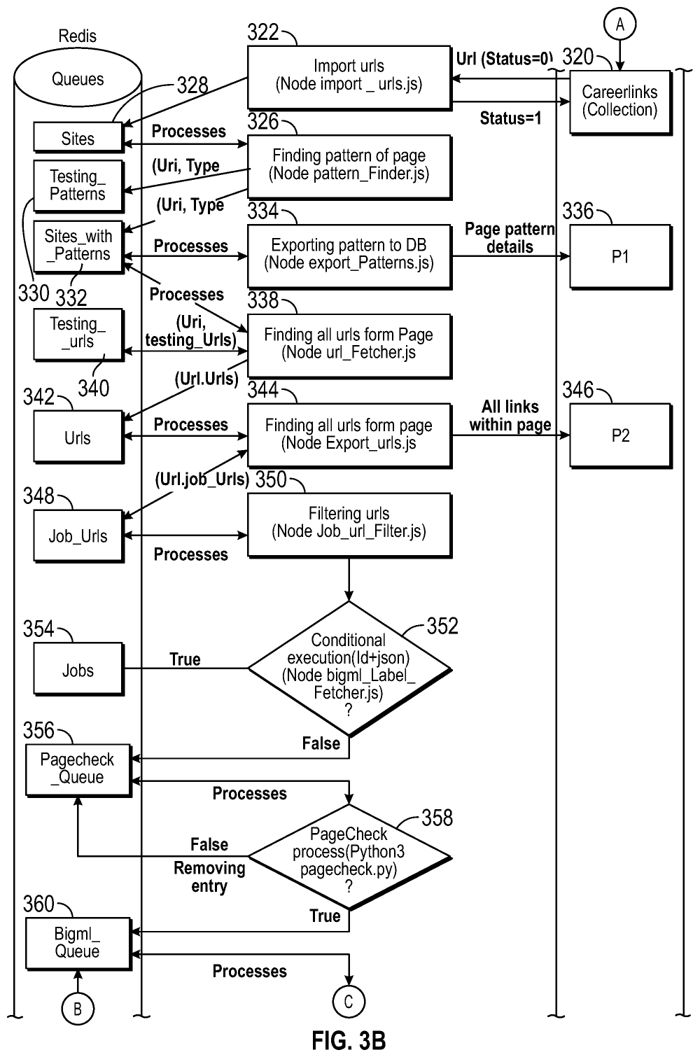

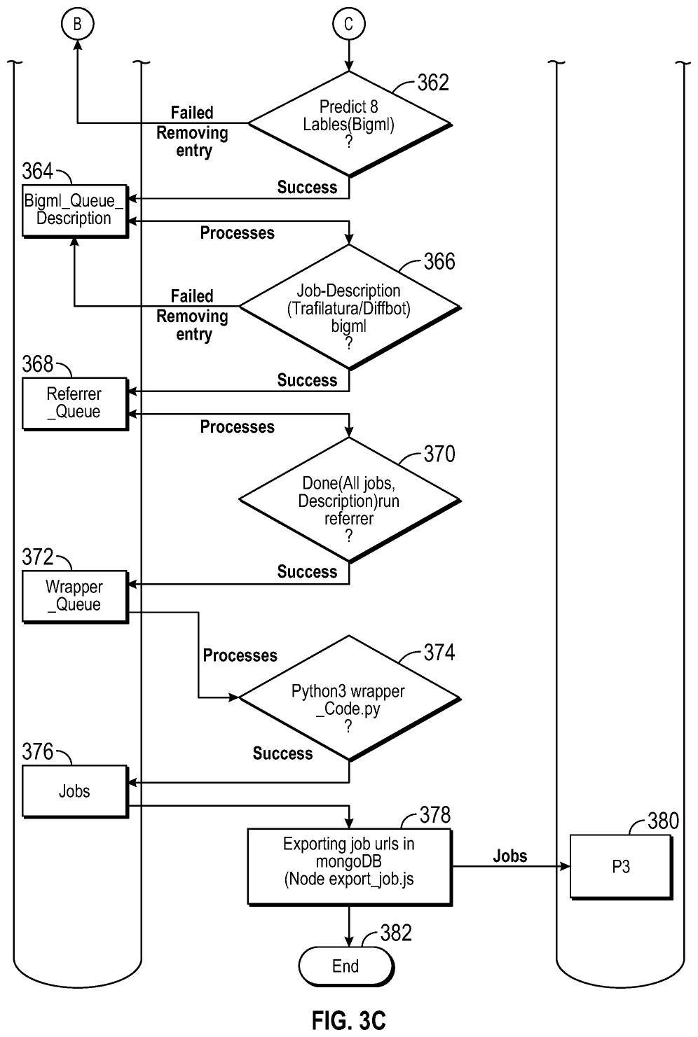

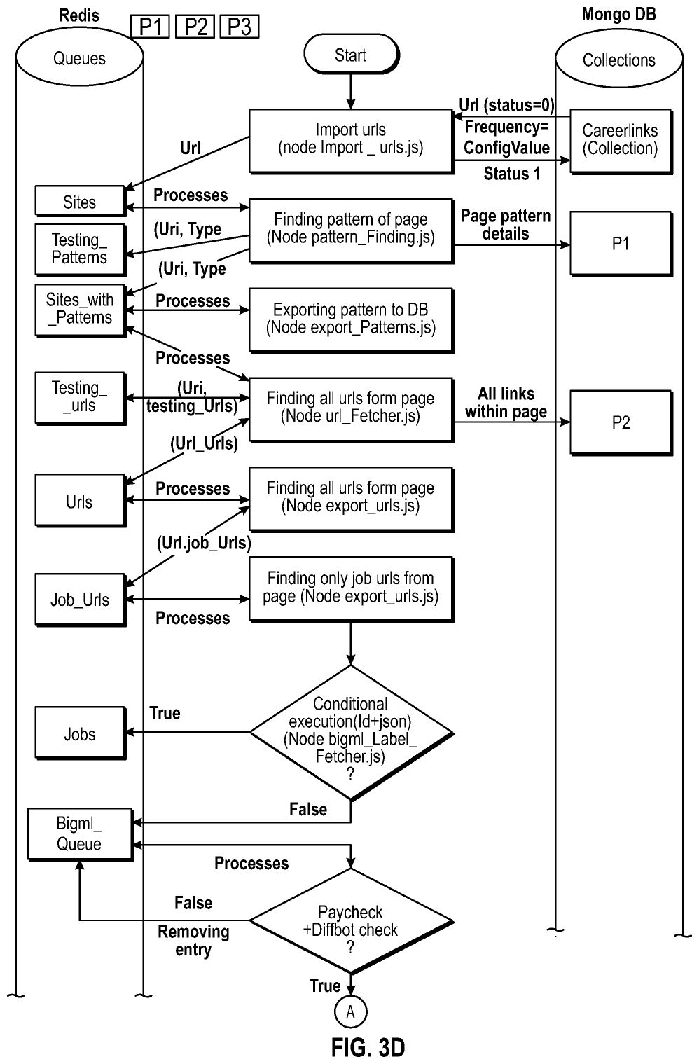

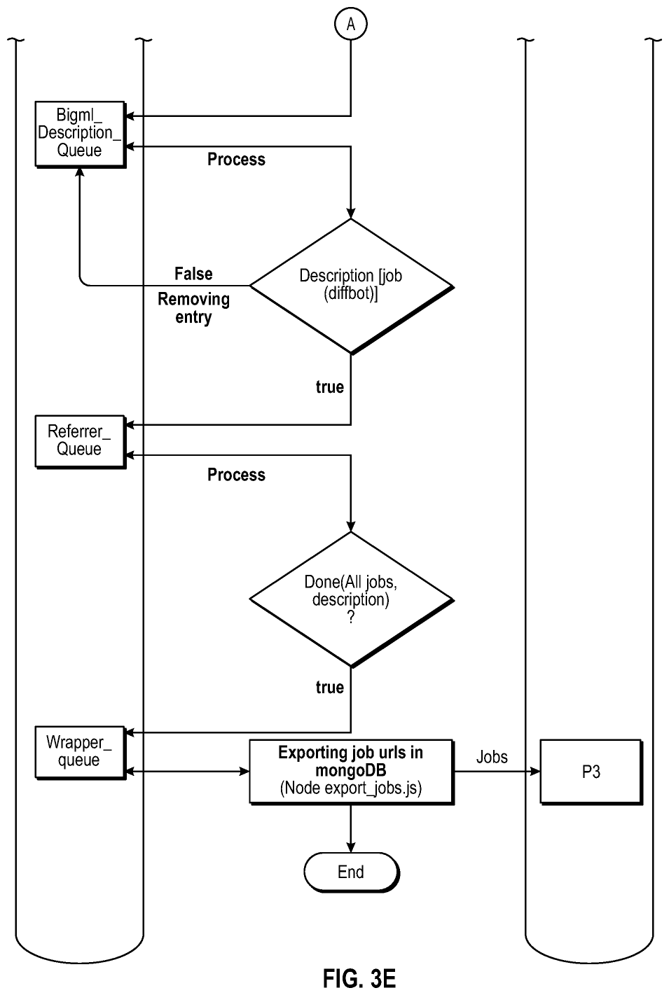

FIG. 3A is a first part of a simplified data flow diagram of the process 100. As mentioned, a domain URL 102 from a raw data list or collection is pinged 104, and if successful, the page is traversed (e.g., crawled) 106 and all links may be input to a select links ML model 302, to identify a potential job pages, potentially down to depth level 5. This may be performed by traversing the target web pages 304 and the select links ML model 302 may be constructed from a corpus of company web sites known to contain job listings.

In some embodiments, each potential job or career page (link) is input to an IsJobListing ML classifier model 306 to assign a category such as, for example, [CAREER PAGE, JOBLISTING PAGE, NON-CAREERPAGE]. It should be appreciated that the IsJobListing Model Classifier 306 may be the same as the IsJobListing Classifier 208 from other embodiments described herein. In this application, the names of ML models are not critical, they are merely offered as generally descriptive. In an embodiment, features used in an ML model for three categories of job pages may include one or more the following:
url
html
Plaintext
job titles (extracted using bigml labels)
job titles count (extracted using bigml labels)
keywords (look for specific keywords presence, collected manually)
title case words count

Of course, the above list is not exhaustive and should be construed as limiting, as the variables identified are only listed as examples of data that may be gathered and passed. The career page links identified by the IsJobListing Model classifier 306 may be input to an ML single career page predictor ML model 308 to predict whether the page is a single job listing page. This company job listing page 310 may be added to the database, which is represented by the collections 312. That page (e.g., link) may be input to another ML model, such as the Multiple Jobs Prediction Model 314. As the name implies, the Multiple Jobs Prediction Model 314 may determine whether the page is likely to list multiple jobs on the same page. In some embodiments, the Multiple Jobs Prediction Model 314 may execute one or more machine learning algorithms to determine whether multiple jobs are listed on one page, which may include the following features:
url
job title count
title position median
description sentence count
html (after removing header, footer, sidebar and javascript code)
plaintext from above html

These may be identified and parsed to acquire the data necessary to list the jobs in the database 312. Again, this multiple jobs career page may be added to a collection 312, such as in a Multiple Jobs Career Page 316 entry for later reference. A career page check 318 may check whether a given page contains job listings, which can then be sent to a career links collection 320 (FIG. 3B).

FIG. 3B continues from the bottom of FIG. 3A. It illustrates an analysis used to find and save page patterns, and to find all URLs (links) from each page; these may be tested, confirmed and stored. The process may test and filter to identify all the pages that have jobs. Finally, the job data is imported and processes, using prediction if necessary to complete at least a minimum set of labels for the job description.

FIG. 3C is a continuation of FIG. 3B showing a portion of the process in which the careerLinks 320 information is imported 322, including URLs. The data may be imported and sent to one or more queues 324, and be stored in a data structure, which may be a database, cache, and/or message broker, or some other data structure accessible by one or more processors. The system may proceed by finding a pattern of page 326, which may draw data from the queues 324, such a sites 328, and may write discovered patterns to one or more entries, such as testing patterns 330 and/or sites with patterns 332.

The data may continue to be parsed and/or be exported 334 to a suitable database such as one determining and storing page pattern details 336. The sites with patterns 332 may be fed, at step 338, into another process to find all URLs from a page. The URLs found on a page may be tested, such as at step testing_URLs 340. Once tested, the URLs 342 may be stored in the data structure 324. The stored URLs from step 342 may be exported, at step 344 and stored as allLinks within a page 346.

The URLs from a page discovered at step 344 may be fed to a job_URLs 348 and stored in the queues 324. The job_URLs at 348 may be fed to a filter, to filter the URLs 350 based on one or more criteria.

The filtered URLs from step 350 may be subject to conditional execution 352 to determine whether the URLs relate to jobs, in which case the jobs URLs=true may be stored in the queues, at 354, as jobs. If the jobs URLs=false, the result may be sent through a pagecheck process queue 356 for execution through a pagecheck Process 358. If true, the data may be sent to a bigml_queue 360.

From the bigml_queue 360, the process may proceed to a Predict 8 Labels 362 process which may iterate through the bigml_queue 360 and remove entries, where necessary. Successful label prediction results may be sent to the bigml_queue_description queue 364.

The label prediction results from the bigml_queue_description 364 may be routed through the Job-Description 366 process and successful results may be sent to the referrer queue 368, while failed results may be iterated and/or removed from the system. The data that proceed through the referrer queue 368 may be sent to the done run referrer 370 process and successful results may be sent to the wrapper_queue 372. From the wrapper queue 372, data is sent other wrapper code 374. While the wrapper code 374 (and other processes described herein) may take advantage of python code and/or libraries, it should be appreciated that any suitable coding, language, libraries, and databases may be used to implement the various embodiments described herein.

In some cases, successful results may sent to a jobs queue 376 and subsequently exported to exporting jobs URLS 378 to any suitable data structure, such as a database where it may be stored at P3 380. The process may then be repeated on additional URLs, suspected employer website, or job posting locations before the process ends at 382.

FIG. 3D illustrates similar embodiments as FIGS. 3A-3C where like boxes represent like processes. A person of ordinary skill in the art will recognize that processes or methods disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein. Furthermore, the processes and methods describe herein may be performed by one or more processors executing instructions that cause the one or more processors to execute the described steps.

FIG. 3E is a continuation of FIG. 3D and continues with the described process of embodiments described herein.

### Multi-Job Pages

Many small companies may not use the usual job listing tools. Those tools provide layout and formatting for job listings that makes them easier to find and import, especially by automated processes. They typically provide a separate link to each job listing. Some companies instead just list all of their current job openings on a single web page. In this case, there is no link that can be followed to each job listing to obtain the listing details for incorporation into automated systems.

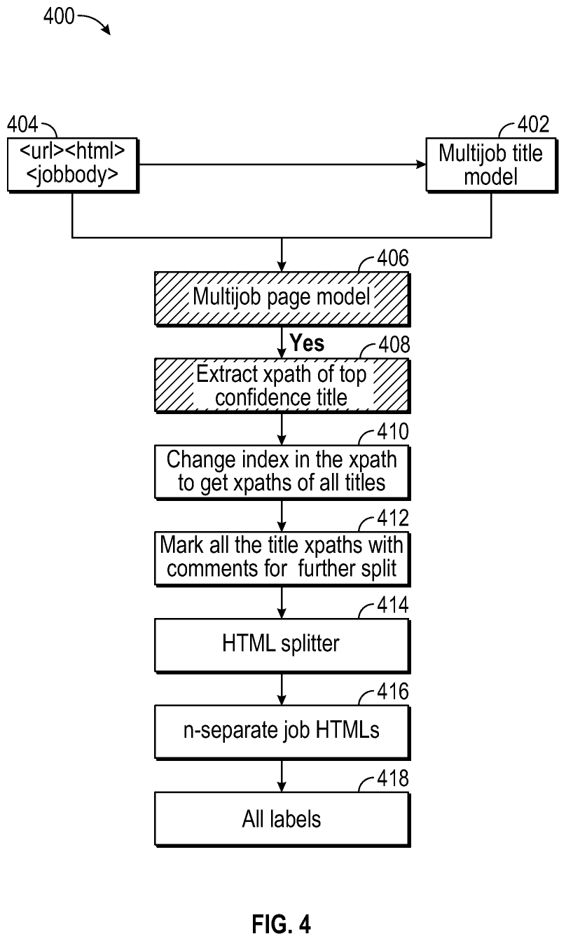

FIG. 4 is a high-level, simplified flow diagram of an example process 400 to identify individual jobs that are listed on a single (omnibus) web page. Here a MultiJob Title ML model 402 may be used to locate a first title field or heading in the page 404. In an embodiment, an ML model to find titles where multiple jobs are listed on one page may include one or more of the following features:
is_html_header
is_bold
character size
is_titlecase
1s_uppercase
number of words in sentence
frequency (of the sentence in document)
first_term (first word)
last_term (last word)
url_match (title match to url)

Of course, other features may be included in the ML model. A MultiJob Page Model 406 may find the titles and, at step 408, extract xpath of top confidence titles. At step 410, the index in the xpath may be varied (e.g., incremented) to get the xpaths of all titles in the page. At step 412, the title xpaths may be marked for a further split. At step 414, a splitter process, such as an HTML splitter process, may be applied for each title, and at step 416, may form n separate job HTMLs. In some cases, for each individual job, the description information is extracted to form required labels at step 418. Each job can then be imported into the database, such as for storing, subsequent analysis, and updating.

### New Jobs Listings

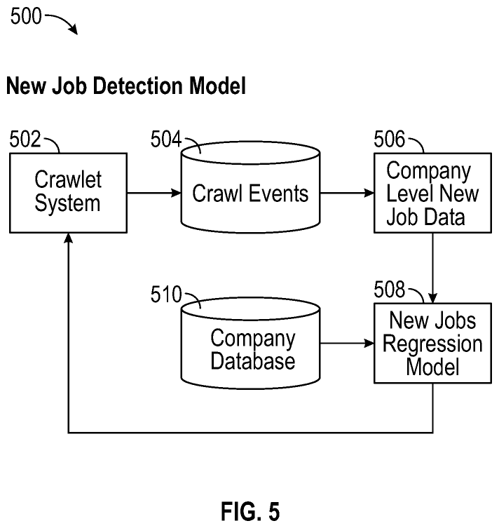

Many new jobs are posted every day, such as hundreds, thousands, tens of thousands, millions, or more. It can be difficult to find all of them and keep a database of job listings current. As noted earlier, it is not practical to visit thousands of web sites, for example, on a daily basis, and extract potentially millions of jobs, and then compare those jobs to an existing database all in order to detect new jobs added since the last check. FIG. 5 is a high-level, simplified flow diagram of an example process to identify new jobs listings to update a jobs database 500. According to some embodiments, a process may be implemented as follows.

A crawler system 502 crawls websites and scrapes jobs data, which may be done generally as described above. The crawler system 502 collects and stores crawl events 504—including new job postings, (i.e., new job events.) A machine learning (ML) model may be built from the dataset of company level new job data 506. In some embodiments, a regression model may be used to predict a number of new jobs likely to be posted by a given company since the last crawl. While a regression model is used as an example, it should be appreciated that any suitable machine learning algorithm may be used to predict the addition or expiry of job data, and may include, without limitation, linear models, lasso models, ridge models, decision tree models, random forest models, gradient boosting decision trees, support vector machines, nearest neighbor, Knn regressors, neural networks, deep neural networks, multiple regression models, multivariate regression models, mixed models, elastic searches, partial least square regressions, logistic regressions, Bayesian models, and others.

In some embodiments, an ML model for predicting a number of jobs added by a company may include one or more of the following features, among others:
location
company
job category
number of jobs existing for a company on a particular day
number of jobs expired for a company on a particular day
average expiry time of a job in given company
average expiry time of a job in given job category

An existing company database 510 (for example, the list of employers mentioned above) may be input to the model to predict the number of new jobs for each company. The system may select the companies with the highest predicted number of new jobs and recheck only those sites to scrape new job postings on a prioritized basis which may result in scraping the sites of the highest predicting 2%, or 5%, or 10% or 15%, or 20% of company websites more often than other web sites. This technique dramatically reduces the time and cost to stay current on new job postings.

### Jobs Expiring

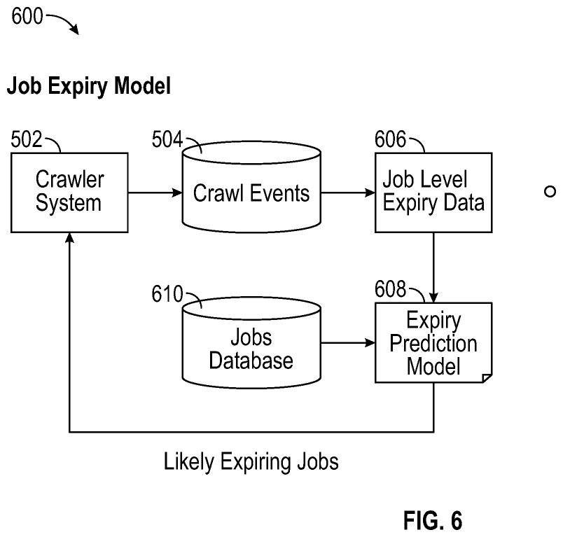

FIG. 6 is a high-level, simplified flow diagram of an example process to predict job listing expirations to update a jobs database 600. Here, the crawler system 502 captures and stores crawl events 504, including when jobs expire. It does this by observing jobs, including those added and removed, over a period of time, preferably over several months. The job level expiry data 606 is used to build an expiry prediction model 608, which may be an ML model, that predicts a likelihood that a given job is going to expire soon, such as the same day. In some embodiments, the expiry model 608 utilizes numerous parameters (aka features), which may include one or more of the following, among other parameters:
location
job category
posted date
average expiry time of a job in given company
average expiry time of a job in given job category

The jobs database 610 may be input to the model, and the jobs that are most likely to expire within a predetermined period of time may be individually rechecked or re-crawled. If expired, a job listing can be so marked or removed from the jobs database 610. This technique dramatically reduces the time and cost to stay current on removing expired job listings.

According to example embodiments, the systems and/or methods described herein may be under the control of one or more processors. The one or more processors may have access to computer-readable storage media (“CRSM”), which may be any available physical media accessible by the processor(s) to execute non-transitory instruction stored on the CRSM. In one basic implementation, CRSM may include random access memory (“RAM”) and Flash memory. In other implementations, CRSM may include, but is not limited to, read-only memory (“ROM”), electrically erasable programmable read-only memory (“EEPROM”), or any other medium which can be used to store the desired information, and which can be accessed by the processor(s).

The disclosure sets forth example embodiments and, as such, is not intended to limit the scope of embodiments of the disclosure and the appended claims in any way. Embodiments have been described above with the aid of functional building blocks illustrating the implementation of specified functions and relationships thereof. The boundaries of these functional building blocks have been arbitrarily defined herein for the convenience of the description. Alternate boundaries can be defined to the extent that the specified functions and relationships thereof are appropriately performed.

The foregoing description of specific embodiments will so fully reveal the general nature of embodiments of the disclosure that others can, by applying knowledge of those of ordinary skill in the art, readily modify and/or adapt for various applications such specific embodiments, without undue experimentation, without departing from the general concept of embodiments of the disclosure. Therefore, such adaptation and modifications are intended to be within the meaning and range of equivalents of the disclosed embodiments, based on the teaching and guidance presented herein. The phraseology or terminology herein is for the purpose of description and not of limitation, such that the terminology or phraseology of the specification is to be interpreted by persons of ordinary skill in the relevant art in light of the teachings and guidance presented herein.

The breadth and scope of embodiments of the disclosure should not be limited by any of the above-described example embodiments but should be defined only in accordance with the following claims and their equivalents.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

Unless otherwise noted, the terms “connected to” and “coupled to” (and their derivatives), as used in the specification, are to be construed as permitting both direct and indirect (i.e., via other elements or components) connection. In addition, the terms “a” or “an,” as used in the specification, are to be construed as meaning “at least one of.” Finally, for ease of use, the terms “including” and “having” (and their derivatives), as used in the

The specification and annexed drawings disclose examples of systems, apparatus, devices, and techniques that may provide automated sourcing, updating, filtering, and displaying of jobs data based upon predictive machine learning models. It is, of course, not possible to describe every conceivable combination of elements and/or methods for purposes of describing the various features of the disclosure, but those of ordinary skill in the art recognize that many further combinations and permutations of the disclosed features are possible. Accordingly, various modifications may be made to the disclosure without departing from the scope or spirit thereof. Further, other embodiments of the disclosure may be apparent from consideration of the specification and annexed drawings, and practice of disclosed embodiments as presented herein.

Examples put forward in the specification and annexed drawings should be considered, in all respects, as illustrative and not restrictive. Although specific terms are employed herein, they are used in a generic and descriptive sense only, and not used for purposes of limitation.

Those skilled in the art will appreciate that, in some implementations, the functionality provided by the processes and systems discussed above may be provided in alternative ways, such as being split among more software programs or routines or consolidated into fewer programs or routines. Similarly, in some implementations, illustrated processes and systems may provide more or less functionality than is described, such as when other illustrated processes instead lack or include such functionality respectively, or when the amount of functionality that is provided is altered.

In addition, while various operations may be illustrated as being performed in a particular manner (e.g., in serial or in parallel) and/or in a particular order, those skilled in the art will appreciate that in other implementations the operations may be performed in other orders and in other manners. Those skilled in the art will also appreciate that the data structures discussed above may be structured in different manners, such as by having a single data structure split into multiple data structures or by having multiple data structures consolidated into a single data structure.

Similarly, in some implementations, illustrated data structures may store more or less information than is described, such as when other illustrated data structures instead lack or include such information respectively, or when the amount or types of information that is stored is altered. The various methods and systems as illustrated in the figures and described herein represent example implementations. The methods and systems may be implemented in software, hardware, or a combination thereof in other implementations. Similarly, the order of any method may be changed and various elements may be added, reordered, combined, omitted, modified, etc., in other implementations.

From the foregoing, it will be appreciated that, although specific implementations have been described herein for purposes of illustration, various modifications may be made without deviating from the spirit and scope of the appended claims and the elements recited therein. In addition, while certain aspects are presented below in certain claim forms, the inventors contemplate the various aspects in any available claim form. For example, while only some aspects may currently be recited as being embodied in a particular configuration, other aspects may likewise be so embodied. Various modifications and changes may be made as would be obvious to a person skilled in the art having the benefit of this disclosure. It is intended to embrace all such modifications and changes and, accordingly, the above description is to be regarded in an illustrative rather than a restrictive sense.

What is claimed is:

1. A method for automatically updating a jobs database, the method comprising:
executing a crawler system, the crawler system configured to scrape data from one or more job listings web sites;
performing, by the crawler system, crawl events comprising new job data;
executing a machine learning model on the new job data to predict a number of new jobs likely to be posted by an employer within a first period of time;
determining that a likelihood of an employer posting a new job within the first period of time is above a threshold likelihood; and
executing a second crawl event on the employer.

2. The method as in claim 1, wherein the machine learning model comprises features including one or more of a location, a company, a job category, a number of jobs existing for the employer on a particular day, a number of jobs expired for a the employer on the particular day, a first average expiry time of a job with the employer, and a second average expiry time of a job in a job category.

3. The method as in claim 1, further comprising presenting, in a user interface of a display, the new job data.

4. The method as in claim 1, wherein the crawl events further comprise job expiration data and further comprising determining, based at least in part on an expiry prediction model, a likelihood that a given job will expire by a second time.

5. The method as in claim 4, further comprising performing, based on the expiry prediction model and at the second time, a third crawl event to determine that the given job has expired.

6. The method as in claim 5, further comprising removing, the given job, from a database of open jobs.

7. The method as in claim 1, wherein the machine learning model comprises a regression algorithm.
